(19) United States
(12) Patent Application Publication
(10) Pub. No.: US 2002/0114320 A1
(43) Pub. Date: Aug. 22, 2002

(54) Method and system for providing multiple packet connections for a circuit connection across a circuit-to-packet interworking unit

(76) Inventor: Eric K. Ogren, Colorado Springs, CO (US)

Correspondence Address: Siemens Corporation, Intellectual Property Depatment, 186 Wood Avenue South, Iselin, NJ, 08830, US

(21) Appl. No.: 09/791,454

(22) Filed: Feb. 22, 2001

(51) Int. Cl. H04L 12/66; H04J 3/06

(52) U.S. Cl. 370/352; 370/516

(57) ABSTRACT

A method and system for providing multiple packet channels for a circuit channel across a circuit-to-packet interworking unit includes establishing a circuit channel and a plurality of packet channels. Each of the packet channels is associated with a the circuit channel. A first one of the packet channels is selectively connected to the circuit channel to provide and end-to-end connection between a circuit endpoint and a first packet endpoint. A second packet channel is maintained for selective connection to the circuit channel to provide a second end-to-end connection between the circuit endpoint and a second packet endpoint.

### RELATED APPLICATIONS

This application is related to U.S. patent application Ser. No.______ entitled “Method and System for Alignment of Streaming Data Between Circuit and Packet Domains of a Communication System” and U.S. patent application Ser. No.______ entitled “A Method and System for Translating Between Circuit and Packet Identifiers for a Communication Connection” all filed on Feb. 22, 2001.

### TECHNICAL FIELD OF THE INVENTION

This invention relates generally to the field of communications systems, and more particularly to a method and system for providing multiple packet connections for a circuit connection across a circuit-to-packet interworking unit.

### BACKGROUND OF THE INVENTION

Communication systems typically provide voice services over circuit-switched networks in which there is a single unbroken circuit between the sender and the receiver of the voice stream. Once a connection is made over the network, the physical circuit remains exclusively dedicated to the connection to the exclusion of all other connections even if there is no voice traffic at a particular time, such as when the connection is on hold.

Data services are typically provided over packet-switched networks in which information is sent in many sections, or packets, over one or more physical transmission routes and then reassembled at the receiving end. Because information is sent in packets, physical transmission interfaces and other transmission resources can be shared among more than one user and/or among more than one data stream. Accordingly, bandwidth is more efficiently utilized than in circuit-switched networks. To provide voice services over packet-switched networks, voice over Internet protocol (VOIP) and other standards have been developed. For wireless networks in which voice traffic is transported in the global system for mobile communication (GSM), code division multiple access (CDMA) and other protocol specific circuit frames over the wireless interface, however, little or no circuit-to-packet conversion standards have been developed.

### SUMMARY OF THE INVENTION

The present invention provides a method and system for supporting multiple packet connections for a circuit connection across a circuit-to-packet interworking unit that substantially eliminates and reduces problems and disadvantages associated with previous systems and methods. In particular, a main circuit path is connected to one or more packet sub-paths to allow switching of multiple packet channels onto the single circuit channel.

In accordance with one embodiment of the present invention, a method and system for providing multiple packet channels for a circuit channel across a circuit-to-packet interworking unit includes establishing a circuit channel and a plurality of packet channels. Each of the packet channels is associated with the circuit channel. A first one of the packet channels is selectively connected to the circuit channel to provide an end-to-end connection between a circuit endpoint and a first packet endpoint. A second packet channel is maintained for selective connection to the circuit channel to provide a second end-to-end connection between the circuit endpoint and a second packet endpoint.

More specifically, in accordance with a particular embodiment of the present invention, the circuit channel is associated with the plurality of packet channels in a bearer path mapping table. In this embodiment, a connection status for each of the packet connections is maintained in the table. Traffic from the circuit channel is provided to a packet channel having an enabled connection status. Similarly, traffic from a packet channel having an enabled status is provided to the circuit channel.

Technical advantages of one or more embodiments of the present invention include providing a method and system for establishing and maintaining multiple packet connections for a circuit connection across a circuit-to-packet interworking unit. In particular, multiple packet channels are selectively switched onto a single circuit channel to support supplementary voice services such as call waiting, call hold, and the like. Accordingly, enhanced and differentiated services may be provided by wireless network operators.

Another technical advantage of one or more embodiments of the present invention includes providing supplementary services in connection with a modular circuit-to-packet interworking function. In particular, multiple packet channels are identified and maintained in a bearer path mapping table used to correlate circuit and packet identifiers for efficient translation without integration of circuit and packet signaling systems.

Other technical advantages of the present invention will be apparent to one skilled in the art from the following figures, description and claims.

### BRIEF DESCRIPTION OF THE DRAWINGS

For a more complete understanding of the present invention and its advantages, reference is now made to the following description taken in conjunction with the accompanying drawings, wherein like numerals represent like parts, in which:

FIG. 1 is a block diagram illustrating an integrated communication system including a circuit and packet domains in accordance with one embodiment of the present invention;

FIG. 2 is a block diagram illustrating details of the wireless adjunct Internet platform (WARP) of FIG. 1 in accordance with one embodiment of the present invention;

FIG. 3 is a block diagram illustrating details of the transreceiver rate adaptation and alignment unit (TRAAU) unit of FIG. 2 in accordance with one embodiment of the present invention;

FIGS. 4A-B are block diagrams illustrating details of the uplink and downlink bit buckets of FIG. 3 in accordance with one embodiment of the present invention;

FIG. 5 is a state diagram illustrating details of the state machine of FIG. 3 in accordance with one embodiment of the present invention;

FIG. 6 is a flow diagram illustrating operation of the jitter buffer of FIG. 3 in accordance with one embodiment of the present invention;

FIG. 7 is a flow diagram illustrating operation of the add unit of FIG. 3 in accordance with one embodiment of the present invention;

FIG. 8 is a flow diagram illustrating a method for processing uplink traffic in the TRAAU of FIG. 3 in accordance with one embodiment of the present invention;

FIG. 9 is a flow diagram illustrating a method for processing downlink traffic in the TRAAU of FIG. 3 in accordance with one embodiment of the present invention;

FIG. 10 is a block diagram illustrating details of the packet interworking unit of FIG. 2 in accordance with one embodiment of the present invention;

FIG. 11 is a block diagram illustrating details of the circuit-to-packet interworking unit of FIG. 10 in accordance with one embodiment of the present invention;

FIG. 12 is a block diagram illustrating details of the bearer path mapping table of FIG. 11 in accordance with one embodiment of the present invention;

FIG. 13 is a block diagram illustrating multiple path connections through the circuit-to-packet of FIG. 11 in accordance with one embodiment of the present invention;

FIG. 14 is a flow diagram illustrating a method for call set up in the circuit-to-packet of FIG. 11 in accordance with one embodiment of the present invention;

FIG. 15 is a flow diagram illustrating a method for processing uplink traffic in the circuit-to-packet of FIG. 11 in accordance with one embodiment of the present invention; and

FIG. 16 is a flow diagram illustrating the method for processing downlink traffic in the circuit-to-packet of FIG. 11 in accordance with one embodiment of the present invention.

### DETAILED DESCRIPTION OF THE INVENTION

FIG. 1 illustrates an integrated communications system 10 in accordance with one embodiment of the present invention. In this embodiment, the communication system 10 includes a wireless circuit domain and a wireline packet domain connected by a circuit-to-packet interworking function operable to provide end-to-end connections across the domains. It will be understood that the communications system 10 may include other suitable circuit domains in which traffic is transported in dedicated circuits and/or other suitable packet domains in which traffic is segmented and transported in one or more shared links.

Referring to FIG. 1, the communications system 10 includes an office network 12, an internet protocol (IP) network 14, a PBX network 16, a public switched telephone network (PSTN) 18, and a public land mobile network (PLMN) 20 connected by links 22. The links 22 may be twisted pair, cable, optic fiber and/or any other suitable wireline or wireless transmission links.

The office network 12 provides cellular or other wireless coverage for mobile stations, or devices, 30 in an office building, corporate campus, or other structure or set of structures. The office network 12 selectively connects the mobile devices 30 with IP telephones 32 through the IP network 14, remote wireless devices 34 through the IP network 14 and the PLMN 20, and standard telephones 36 through the IP network 14 and the PBX network 16 and/or the PSTN 18.

As described in more detail below, the office network 12 receives voice and other streaming data from mobile devices 30 over circuit connections, or channels, and packetizes the voice data for transmission in packet connections, or channels, over the IP network 14. At the edge of the IP network 14, the packetized voice data may be converted back to a circuit format for transmission in the PBX network 16, the PSTN 18 and/or the PLMN 20. Similarly, traffic destined for mobile devices 30 from the PBX network 16, the PSTN 18 and the PLMN 20 is packetized at a gateway to the IP network 14 for transmission over packet channels and then converted back to the wireless circuit format at the office network 12 for delivery to the mobile devices 30 over circuit channels. In this way, traffic from a mobile device 30 coupled to the office network 12 may be efficiently transmitted over the IP network 14 and delivered to any suitable type of circuit or packet endpoint.

In one embodiment, the office network 12 includes a wireless subsystem (WSS) 40 and a packet-switching subsystem (PSS) 42. The WSS 40, PSS 42, as well as components and units of each subsystem and other components of the communications system 10 may comprise logic encoded in media for implementing the functionality of the devices. The logic comprises functional instructions for carrying out program tasks upon and/or during execution. The media comprises computer disks or other computer-readable media, application-specific integrated circuits (ASIC), field programmable gate arrays (FPGA), digital signal processors (DSP), other suitable specific or general purposes processors, transmission media or other suitable media in which logic may be encoded and utilized.

The WSS 40 includes a plurality of base station subsystems (BSSs) 50 and a subscriber location register (SLR) 52. Each BSS 50 includes a plurality of base transceiver station (BTS) 54 and a wireless adjunct Internet platform (WARP) 56. Each BTS 54 communicates with mobile devices 30 in a defined coverage area over a radio frequency link (RF) 58 and with WARP 56 over links 60. The mobile devices 30 may be cellular telephones, handsets, pagers, and any other suitable device operable to communicate information over the RF link 58. In one embodiment, the BTSs 54 and mobile devices 30 communicate over the RF link 58 using the global system for mobile communication (GSM) protocol. In this embodiment, an E1 circuit channel is defined between each mobile device 30 and the WARP 56 over the RF and wireline links 58 and 60. As used herein, the term each means every one of at least a subset of the identified items.

The WARP 58 includes circuit-to-packet interworking functionality that converts uplink circuit frames to packets for transmission over the IP network 14 and downlink packets to circuit frames for transmission to the mobile devices 30. Accordingly, a circuit domain is defined between the mobile devices 30 and the WARP 56 and a packet domain is defined between the WARP 56 and a remote endpoint which may be an IP device or gateway.

In a particular embodiment, the WARP 56 implements the H.323 protocol for packet transmission. In this embodiment, voice data is transmitted in transmission rate adaption unit (TRAU) frames between the BTSs 54 and WARP 56 and converted to voice over IP (VOIP) packets at the WARP 56. It will be understood that other suitable wireless specific and packet protocols may be used by or in connection with the office network 12 without departing from the scope of the present invention.

The SLR 52 provides subscriber management information for mobile devices 30. The SLR 52 may store the identifiers of each mobile device 30 along with associated quality of service (QoS), class of service (CoS) and other subscription parameters. For example, the SLR 52 may store a full rate (FR) or enhanced full rate (EFR) QoS for each connection.

The PSS 42 comprises an IP PBX 70 and PSS management 72. The IP PBX 70 includes a gatekeeper 74 and a gateway 76. The gatekeeper 74 provides connection setup and control over the IP network 14. The gateway 76 communicates with the IP network 14 using a packet-switched, or packet, protocol and with the PBX network 16 using a circuit-switched, or circuit, protocol. Thus, the gateway 76 and other gateways of the communications system 10 also perform an interworking function to translate between packet-switched and circuit-switched protocols. The PSS management 72 manages the gatekeeper 74 and gateway 76 of the IP PBX 70.

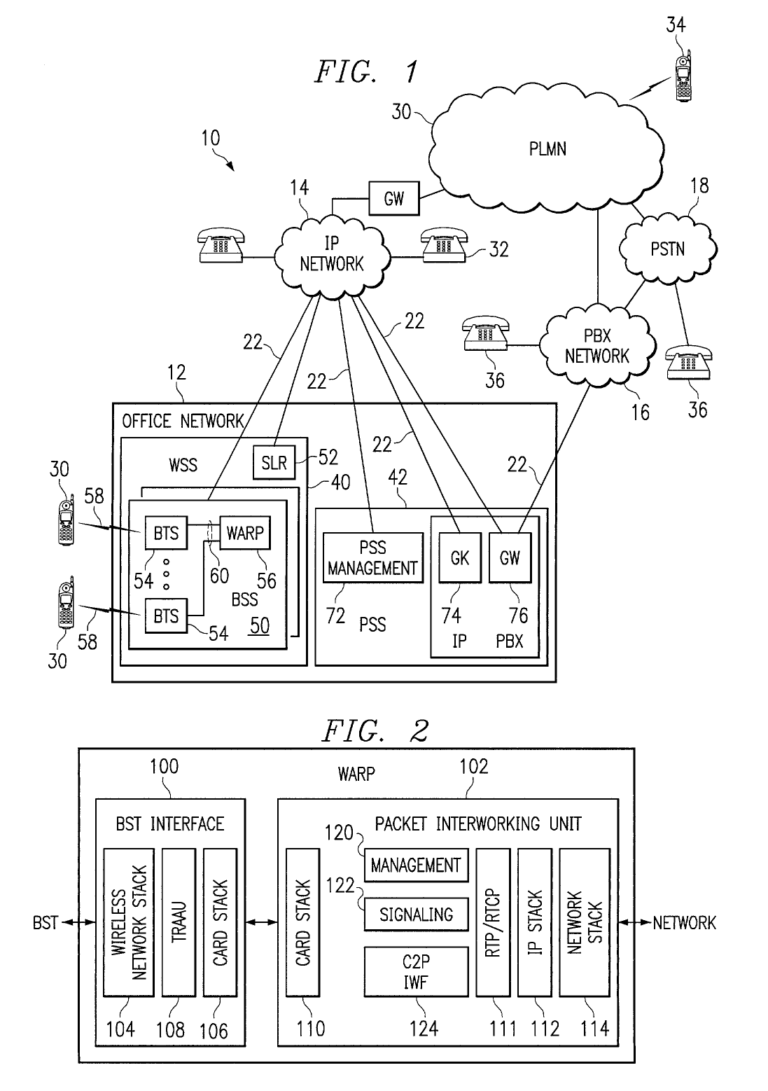

FIG. 2 illustrates details of the WARP 56 in accordance with one embodiment of the present invention. In this embodiment, the WARP 56 includes a BTS interface 100 and a packet interworking unit 102. The BTS interface 100 includes a wireless network stack 104, a card stack 106, and a transceiver rate adaption and adjustment unit (TRAAU) 108. The wireless network stack 104 communicates with the BTSs 54 while the card stack 106 communicates with the packet interworking unit 102.

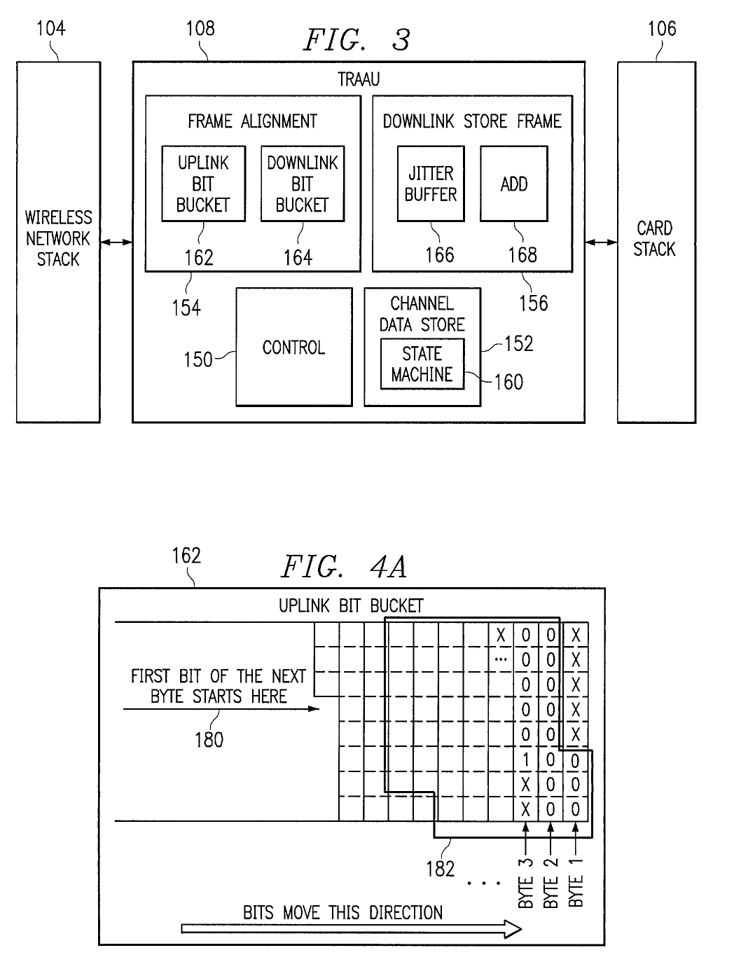

The TRAAU 108 receives, aligns and forwards uplink circuit frames to the packet interworking unit 102 for conversion to packets and transmission over the IP network 14. In the downlink direction, the TRAAU 108 receives circuit frames from the packet interworking unit 102 and performs rate adjustments on the frames based on control signals from the BTSs 54. Further information regarding the TRAAU 108 is described in more detail below in connection with FIGS. 3-9.

The packet interworking unit 102 converts voice and other streaming data, as well as associated address identifiers between the circuit and packet domains of the communications system 10. In one embodiment, the packet interworking unit 102 includes a card stack 110, a real-time protocol (RTP)/real-time control protocol (RTCP) stack 111, an IP stack 112, a network stack 114, a management unit 120, a signaling unit 122, and a circuit-to-packet interworking function (C2P IWF) 124. The card stack 110 communicates with a card stack 106 on the BTS interface 100. The RTP/RTCP stack 111, IP stack 112 and network stack 114 communicate with the IP network 14. In a particular embodiment, the network stack 114 comprises an ethernet driver while card stacks 106 and 110 comprise peripheral component interconnect (PCI) drivers.

The management unit 120 manages the packet interworking unit 102. The signaling unit 122 controls signaling between the circuit and packet domains for connection or call setup, control and teardown. The circuit-to-packet IWF 124 translates bearer traffic between the circuit and packet domains for end-to-end connections across the communication system 10.

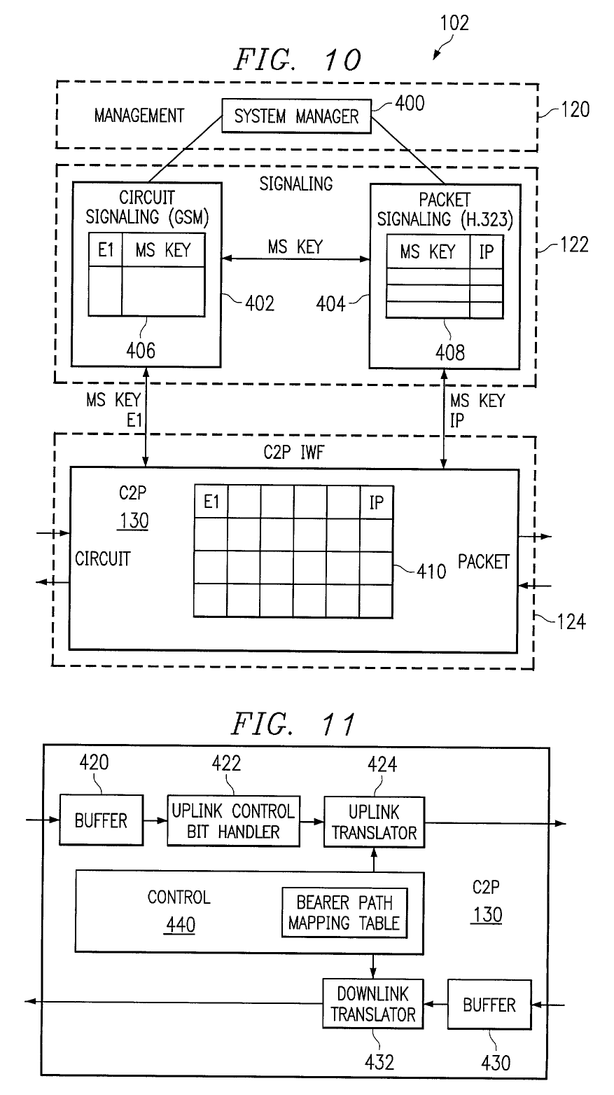

In one embodiment, the circuit-to-packet IWF 124 includes a circuit-to-packet (C2P) unit 130 which may be combined with the RTP/RTCP to form a bearer traffic unit. The circuit-to-packet unit 130 receives uplink circuit frames from a circuit connection and converts the data and addresses to a packet format for transmission in the packet domain. The circuit-to-packet unit 130 also receives downlink packets from the packet domain and converts data and addresses to a circuit format for transmission over a circuit connection. Further information regarding the packet interworking unit 102 and the circuit-to-packet IWF 124 are described in more detail below in connection with FIGS. 10-16.

FIG. 3 illustrates details of the TRAAU 108 in accordance with one embodiment of the present invention. In this embodiment, a single TRAAU 108 is used to process traffic for multiple circuit connections. It will be understood that a separate TRAAU 108 may be insubstantiated for each connection without departing from the scope of the present invention.

Referring to FIG. 3, the TRAAU 108 includes a control unit 150, a channel data store 152, a frame alignment unit 154, and a downlink frame store 156. The control unit 150 controls transmit and receive tasks for uplink and downlink traffic for all connections handled by the TRAAU 108. The control unit 150 performs real-time processing on the uplink and downlink traffic and may comprise a word-oriented processor to carry out bit level rate adaption and alignment functions.

The channel data store 152 is a database which holds state and status information for all ongoing connections. This includes which calls are active, the state of each call, which calls need timing adjustments and the next sequence numbers for the calls. In the GSM embodiment, the channel data store 152 maintains a state machine 160 for each call based on events passed to it by the control unit 150. In this embodiment, the state of the call determines responses to certain queries. For example, once a frame has been time-aligned, the TRAAU 108 waits for three frames to pass before making another adjustment. In a particular embodiment, the timing adjustment bits are converted to a signed integer for storage in the channel data store. In the embodiment, the adjustment may indicate the number of 250 U.S. increments to either advance, negative number, or delay, positive number, the frame.

The frame alignment unit 154 includes an uplink bit bucket 162 and a downlink bit bucket 164 to perform rate adaption and alignment between the circuit and packet domains for uplink and downlink traffic. In one embodiment, the uplink and downlink bit buckets 162 and 164 have bit-level pointers, reports their size in terms of bits and have an interface at the bit level.

The uplink bit bucket 162 holds incoming uplink bits until enough are received to begin extracting circuit frames from the bucket. Incoming bits are added to the top of the uplink bit bucket 162 and pulled from the bottom of the uplink bucket 162 in a first in-first out (FIFO) order. When a circuit frame is requested from the uplink bit bucket 162, the bucket finds a sync pattern to determine where to start copying data from in the bucket. For the GSM protocol, the circuit frames are TRAU frames. In this embodiment, the TRAU frames may be converted to telecommunications Internet protocol harmonization over networks (TIPHON) format.

The downlink bit bucket 164 holds incoming downlink circuit frames and allows adjustment in bits to the frame being added based on timing adjustments requested by the BTSs 54. Downlink bit bucket 164 tracks an insertion point for the next circuit frame in the bucket and shifts incoming bits according to where the last frame ends in the bucket. Thus, incoming bits are added to a top of the downlink bit bucket 164 and pulled from a bottom of the bucket 164 in a FIFO order.

The downlink frame store 156 includes a jitter buffer 166 and an add unit 168. The jitter buffer 166 buffers downlink circuit frames for voice and other streaming connections to remove jitter and/or correct for other time spacing deficiencies, out-of-order packets, packet drops and otherwise improve quality of the connection. The jitter buffer is configurable and sized based on network characteristics. In this way, jitter buffer 166 is operated in connection with a component of the WARP 56 that has an inherent timing source and on a side of the TRAAU 108 that is not synchronous. The add unit 168 inserts downlink circuit frames into the jitter buffer 166 in order such that the circuit frame at the bottom of the jitter buffer 166 is a next frame of those in the buffer to be sent to the downlink bits bucket 164 for timing adjustment and then to the mobile device 30 for playing to the user.

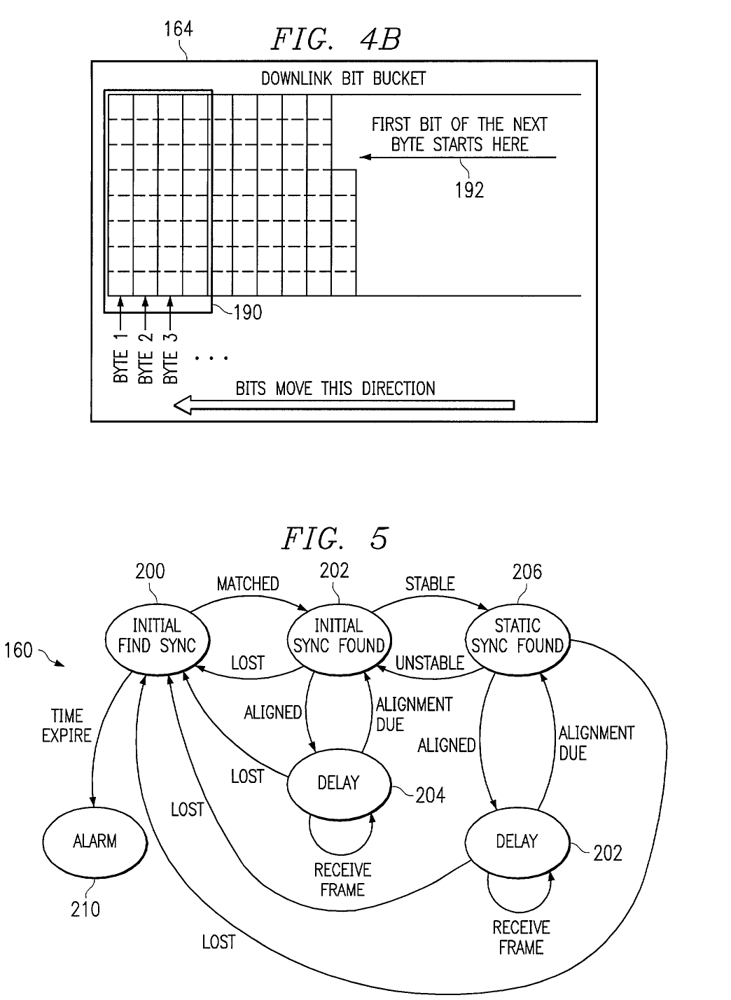

FIGS. 4A-B illustrate the uplink and downlink bit buckets 162 and 164 in accordance with a particular embodiment of the present invention. Referring to FIG. 4A, the uplink bit bucket 162 stores each successive circuit frame at an insertion point 180 at the end of a previous circuit frame 182. There are two copy operations performed in connection with the uplink bit bucket 162. The first copy shifts the incoming bits for placement into the bucket 162 and a second copy shifts the outgoing bits to a byte-aligned state of the packet domain. Accordingly, circuit frames are aligned to the packet domain in the TRAAU 108 and thereafter forwarded to the packet interworking unit 102 for conversion to packets. It will be understood that the uplink circuit frames 182 may be otherwise suitably byte-aligned to the packet domain in the TRAAU 108 or other component of the WARP 56.

Referring to FIG. 4B, the downlink bit bucket 164 stores downlink circuit frames 190 beginning at an insertion point 192 at an end of a previous circuit frame. The downlink bit bucket 164 accepts downlink circuit frames 190 that have been modified by shortening or lengthening a few bits for timing reasons based on timing adjustments from the BTS 54. Thus, the downlink circuit frames 190 may not be a whole number of octets long. There is only one copy operation performed in connection with the downlink bit bucket 164 when the timing adjusted-downlink circuit frame 190 is placed into the downlink bit bucket 164 and un byte aligned and/or bit aligned to the circuit domain. Because whole bytes are passed directly to the wireless network stack 104, no copy occurs out of the downlink bit bucket 164. This, a contiguous bit stream is manufactured from the byte stream and arbitrary timing adjustments with at most two stores per incoming byte.

FIG. 5 illustrates the state machine 160 of the TRAAU 108 for each connection in accordance with one embodiment of the present invention. In this embodiment, the circuit frames are GSM frames in which timing adjustments are only allowed for every third frame to prevent oscillation between the BTS 54 and the TRAAU 108. It will be understood that other suitable state machines 160 may be used to control rate adjustments and other actions for each connection without departing from the scope of the present invention.

Referring to FIG. 5, the state machine 160 includes an initial find sync state 200 in which the uplink bit bucket 162 searches for synchronization bits for a next circuit frame in the bucket. In the initial find sync state 200, large timing adjustments are permitted.

Upon a synchronization match, the initial find sync state 200 transitions to an initial sync found state 202. In the initial sync found state 202, the three frame rule between timing adjustment applies. Accordingly, in response to a timing adjustment for alignment, the initial sync found state 202 transitions to a delay state 204 until receipt of the third frame when alignment is again due. When alignment is due, the delay state 204 transitions back to initial sync found state 202. If sync is lost at the initial sync found state 202 or the delay state 204, the respective states transition back to the initial find sync state 200.

From the initial sync found state 202, once two adjustments of less than 500 us have been made, the connection has stabilized and the initial sync found state 202 transitions to a static sync found state 206. Only small timing adjustments of 250 us are allowed in this state. If this rule is violated, the static sync found state 206 transitions back to the initial sync found state 202. The static sync found state 206 transitions to and from delay state 208 to allow the two unadjusted frames between each frame that has a timing adjustment to be applied to downlink traffic. If sync is lost at the static found state 206 or delay state 208, the respective states transition back to the initial find sync state 200.

At initial find sync state 200, if sync cannot be found within a predefined period of time, the initial find sync state 200 transitions to an alarm state 210 in which operations, administration, & maintenance (OAM) is notified of the sync failure. In this way, the control data store 152 waits three frames before allowing a timing adjustment to be made in any state of the connection and allows timing adjustments only in accordance with the current state of the connection.

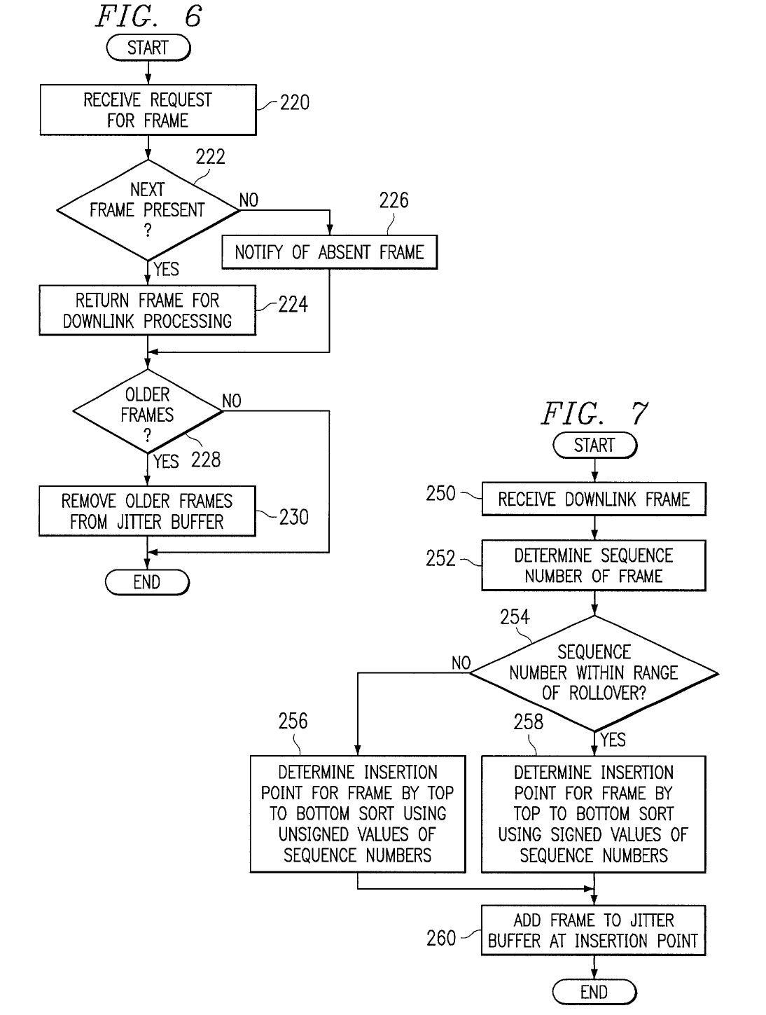

FIG. 6 illustrates a method for operating the jitter buffer 166 in accordance with one embodiment of the present invention. In this embodiment, the method begins at step 220 in which the jitter buffer 166 receives a request for a frame from the control unit 150. The request includes a next sequence number that is recalled from the channel data store 152. Because circuit frames are sorted in the jitter buffer 166 based on sequence number, the jitter buffer 166 need only check a first frame at the bottom of the buffer for a sequence number match.

Proceeding to step 222, if the frame at the bottom of the jitter buffer 166 has a sequence number matching the requested sequence number, the next frame is present in the jitter buffer 166 and the Yes branch of decisional step 222 leads to step 224. At step 224, the next frame is returned for downlink processing. Returning to decisional step 222, if the next frame is not present, the No branch of decisional step 222 leads to step 226 in which the control unit 150 is notified of the absent frame. In this case, the control unit 150 will clean for the absent frame. Steps 224 and 226 each lead to decisional step 228.

At decisional step 228, the jitter buffer 166 determines whether older frames exist in the buffer. If older frames exist in the jitter buffer 166, the Yes branch of decisional step 228 leads to step 230 in which the older frames are removed from the buffer as these frames were received out of order and after they could be used. After the older frames have been removed from the jitter buffer 166, step 230 leads to the end of the process. Similarly, if no older frames exist in the jitter buffer 166, the No branch of decisional step 228 leads to the end of the process in which downlink circuit frames are jitter buffered in the TRAAU 108 and played out to the downlink bit bucket 164 based on synchronous timing requirements of the E1 or other circuit connection.

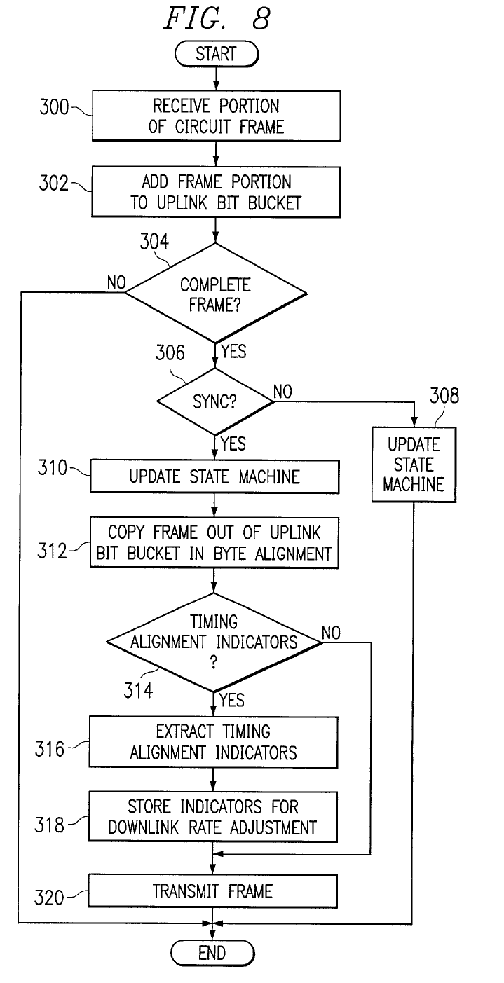

FIG. 7 illustrates a method for operating the add unit 168 for the jitter buffer 166 in accordance with one embodiment of the present invention. In this embodiment, the method begins at step 250 in which a downlink circuit frame is received from the card stack 106. Next, at step 252, a sequence number is determined for the downlink circuit frame. For the GSM embodiment, the downlink circuit frame received from the card stack 106 includes a header with the frame sequence number.

Proceeding to decisional step 254, the add unit 168 determines whether the sequence number is within a specified range of a sequence number rollover point. In one embodiment, the rollover point is zero, and the range is plus or minus the largest number of allowable circuit frames in the jitter buffer 166. The range may be some fraction or multiple of maximum jitter buffer size or other suitable range within the set of sequence numbers.

If the sequence number is not within range of the rollover point, the No branch of decisional step 254 leads to step 256. At step 256, the add function 168 determines an insertion point for the frame in the jitter buffer 166 by a top to bottom sort of currently stored circuit frames using unsigned values of the sequence numbers. Thus, sort time is minimized as frames typically arrive in order and are added to the top of the jitter buffer 166.

Returning to decisional step 254, if the sequence number is within range of the rollover point, the Yes branch of decisional step 254 leads to step 258. At step 258 the add function 168 determines the insertion point for the downlink circuit frame by a top to bottom sort of the jitter buffer 166 using signed values of the sequence numbers. Accordingly, the circuit frames will be properly ordered across a rollover point based on sequence numbers without additional processing resources.

Steps 256 and 258 each lead to step 260. At step 260, the downlink circuit frame is added at the insertion point in the jitter buffer 166. Step 260 leads to the end of the process by which downlink circuit frames are ordered in the jitter buffer 166 to allow the control unit 150 to readily determine whether a next frame for a connection has been received.

FIG. 8 illustrates a method for processing uplink circuit frames in the TRAAU 108 in accordance with one embodiment of the present invention. In this embodiment, the method begins at step 300 in which a portion of a circuit frame is received from the wireless network stack 104. At step 302, the portion of the uplink circuit frame is added to the uplink bit bucket 162. The portion of the frame may be half of a full frame. It will be understood that the uplink circuit frames may be received in other portions or received as whole frames.

Proceeding to decisional step 304, the uplink bit bucket 162 determines whether the complete frame is stored. If a complete frame is not stored, the No branch leads to the end of the process, which is restarted in response to receipt of the next portion of the circuit frame. If a complete frame is stored in the uplink bit bucket 162, the Yes branch of decisional step 304 leads to decisional step 306.

At decisional step 306, the uplink bit bucket 162 searches for sync in the stored circuit frame. If sync cannot be found, the No branch leads to step 308 in which the state machine 160 is updated. Step 308 leads to the end of the process. It will be understood that alarm and error correction may be performed in response to lost sync. If sync is found, the Yes branch of decisional step 306 leads to step 310. At step 310, the state machine 160 is updated to reflect the finding of sync.

Next, at step 312, the uplink circuit frame is copied out of the uplink bit bucket 162 in the byte-alignment of the packet domain. At decisional step 314, the control unit 150 determines whether timing adjustment indicators are included within the uplink circuit frame. If timing indicators are included, the Yes branch of decisional step 314 leads to step 316, in which the timing indicators are extracted from the frame. At step 318, the extracted timing alignment indicators are stored in the channel data store 152 for use in connection with the downlink circuit frames for the connection. Step 318, as well as the No branch of decisional step 314 lead to step 320. At step 320, the uplink circuit frame is forwarded to the card stack 106 for transmission to the packet interworking unit 102. Step 320 leads to the end of the process by which uplink circuit frames are aligned to the packet domain.

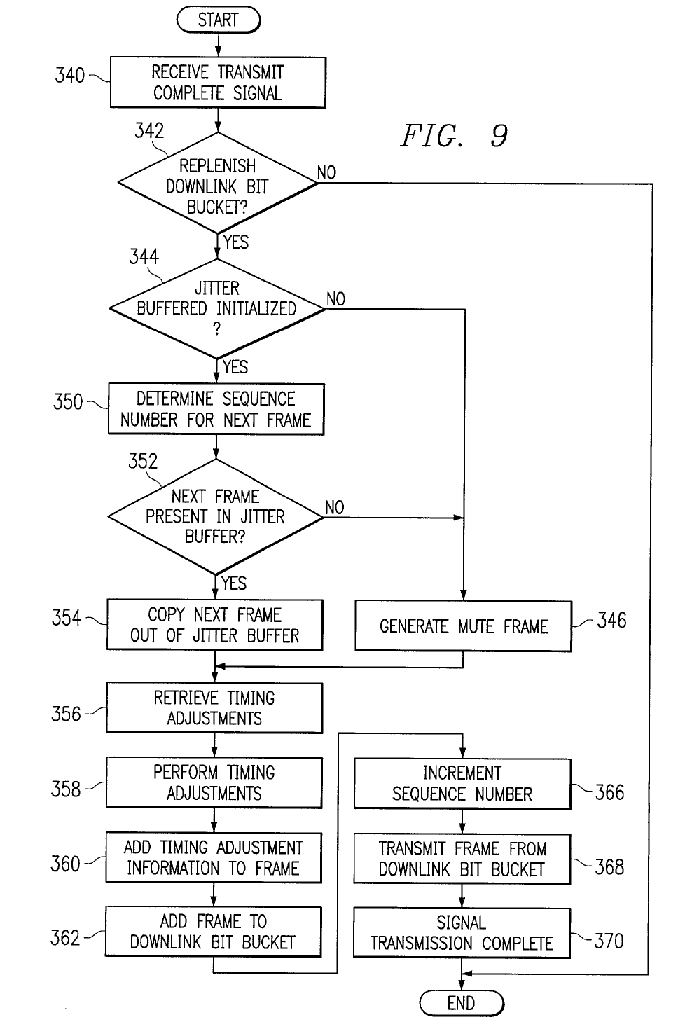

FIG. 9 illustrates a method for processing downlink circuit frames in the TRAAU 108 in accordance with one embodiment of the present invention. In this embodiment, the circuit frames are transmitted in half frame increments to minimize latency over the circuit connection. It will be understood that the downlink circuit frames may be otherwise suitably transmitted without departing from the scope of the present invention.

Referring to FIG. 9, the method begins at step 340 in which a transmit complete signal is received from the wireless network stack 104. Next, at decisional step 342, the control unit 150 determines whether the downlink bit bucket 164 needs to be replenished. One embodiment, the downlink bit bucket 164 needs to be replenished if a full downlink circuit frame has been copied out of the bit bucket since the last replenishment. If the downlink bit bucket 164 is not in need of replenishment, the No branch of decisional step 342 leads to the end of the process which will be restarted in response to receipt of a next transmit complete signal, after which a full downlink circuit frame has been transmitted out of the downlink bit bucket 164. After a full downlink circuit frame has been transmitted out of the downlink bit bucket 164, the bucket needs to be replenished and the Yes branch of decisional step 342 leads to decisional step 344.

At decisional step 344, the control unit 150 determines whether the jitter buffer 166 has been initialized. If the jitter buffer 166 has not been initialed to build up a suitable number of packets prior to starting data delivery to the user, the No branch of decisional step 344 leads to step 346 in which a mute frame with little or no signal strength and/or with comfort noise is generated to provide a frame for delivery to the BTS 54 without pulling data from the jitter buffer 166 as it is being initialized.

Returning to decisional step 344, if the jitter buffer 166 has been previously initialized, the Yes branch leads to step 350. At step 350 a sequence number for next frame is determined by the control unit 150 from the channel data store 152. Next, at decisional step 352, the jitter buffer 166 determines whether the next frame with the requested sequence number is present in the buffer. If the next frame is not present, such has been lost or dropped by the IP network 14, the No branch of decisional step 352 leads to step 346 in which a mute frame is generated for delivery to the BTS 54. If the next frame is present in the jitter buffer 166, the Yes branch of decisional step 352 leads to step 354. At step 354, the next frame is copied out of and deleted from the jitter buffer 166. Steps 354 and 346 in which a next or mute frame is copied or generated lead to step 356.

At step 356, timing adjustment indicators are retrieved from the channel data store 152 based on the state machine 160. At step 358, the downlink circuit frame is modified to generate a timing adjusted-downlink circuit frame by adding or removing bits based on the timing adjustment indicators. At step 360, indication of the timing adjustments performed or added to the modified circuit frame.

Proceeding to step 362, the rate adjusted downlink circuit frame is added to the downlink bit bucket 164. At step 366, the sequence number stored by the control data store 152 is incremented to the next sequential number, which as previously described, may be a rollover number.

Next, at step 368, a portion of an old circuit frame in the downlink bit bucket 164 is forwarded to the wireless stack 104 for transmission to the endpoint mobile device 30. At step 370, a transmission complete signal is provided by the wireless stack 104, which restarts the process. This signal may be received about 20 ms after transmission in step 368. In this way, downlink circuit frames are buffered to prevent starvation of voice and other streaming data applications, rate adjusted for a wireless circuit and synchronously supplied to the wireless circuit in accordance with its timing requirements.

FIG. 10 illustrates details of the packet interworking unit 102 in accordance with one embodiment of the present invention. In this embodiment, the packet interworking unit 102 translates voice and other streaming data between the GSM circuit domain and the H.323 packet domain.

Referring to FIG. 10, the management unit 120 includes a system manager 400 operable to communicate with a circuit signaling unit 402 and a packet signaling unit 404 in the signaling unit 122. The signaling unit 122 may provide addresses of remote end points and may also include a system manager operable to assign unique mobile station (MS) keys to connections.

The circuit signaling unit 204 includes a circuit address table 406 associating a circuit identifier (E1) for each circuit connection to the connection unique MS key. Similarly, the packet signaling unit 404 includes a packet address table 408 associating a packet identifier (IP) for each packet connection with a MS key. The circuit and packet signaling units 402 and 404 communicate information about a connection using the MS key. Accordingly, the signaling units 402 and 404 are modular and need not be intermeshed, can be run independently without being intertwined and can keep standards intact. Thus, the architecture provides transparent voice signaling, decouples signaling from bearer and circuit from packet while allowing task to communicate to provide array of wireless voice services on top of an IP backbone. In addition, all calls are handled in the same manner, such as mobile-to-mobile and mobile-to-PBX.

The circuit-to-packet IWF 124 includes the circuit-to-packet unit 130 that spans between the circuit and packet domains and provides data and address translation for traffic across the domains. In one embodiment, the circuit-to-packet unit 130 includes a three-dimensional bearer path mapping table 410 associating circuit and packet addresses for a connection and directly indexed with the MS key. The table 410 is a shared resource for task in packet interworking unit 102 and may be accessed without or with minimal operating system overhead. Direct indexing the bearer path mapping table 410 with the MS key allows address translation without linearing searching of data and/or use search or sort algorithms which reduces latency in the connections and processing required by the circuit-to-packet unit 130. In addition, as described in more detail below, the bearer path mapping table 410 allows a plurality of the packet channels to be switched onto a single circuit channel for provision of enhanced service to wireless users.

The circuit-to-packet unit 130 communicates with the circuit signaling unit 402 with at least one of the MS key and the circuit identifier. Similarly, the circuit-to-packet unit 130 communicates with the packet signaling unit 404 with at least one of the IP identifier and the MS key. Accordingly, each component of the packet interworking unit 102 may communicate about a connection across the circuit and packet domains using the common MS key.

FIG. 11 illustrates details of the circuit-to-packet unit 130 in accordance with one embodiment of the present invention. In this embodiment, the circuit frames are validated and the invalid frames dropped to eliminate cleaning at translation and thus reduce latency to the streaming data and avoid duplication efforts. Cleaning is performed at a remote endpoint to maintain quality of the connection.

Referring to FIG. 11, the circuit-to-packet unit 130 includes a buffer 420, an uplink bit control handler 422 and an uplink translator 424 in the uplink direction and a buffer 430 and a downlink translator 432 in the downlink direction. A control unit 440 establishes connections in the bearer path mapping table 410 and maintains the status of the connections in the table.

The uplink buffer 420 is a one-deep buffer to minimize delay in uplink processing. The uplink control bit handler 422 validates uplink circuit frames and drops invalid frames. As previously described, invalid frames are cleaned at a remote endpoint to maintain quality while minimizing processing resources in the circuit-to-packet unit 130. The uplink translator 424 translates uplink circuit frames to uplink packets by converting voice and other included data to the packet format and translating the circuit identifier, or address, to a packet identifier, or address, by indexing into the bearer path mapping table 410 with the MS key. In a particular embodiment, the uplink translator 424 may translate data between the circuit and packet domains based on a FR or EFR QoS of the connection. In either case, the formats are converted by any suitable bit shifts that optimize bit manipulations. It will be understood that voice and other data may be otherwise suitably translated between the circuit and packet domains without departing from the scope of the present invention.

The downlink buffer 430 is a one deep buffer to minimize delay in the downlink direction. The downlink translator 432 translates downlink packets to downlink circuit frames by converting voice and other included data to the circuit format and translating the packet address to the corresponding circuit address by indexing into the bearer path mapping table 410 with the MS key. In a particular embodiment, the downlink translator 432 may translate data between the packet and circuit domains based on a FR or EFR QoS for the connection. In either case, the downlink translator 432 converts the traffic using optimized bit manipulations. It will be understood that the downlink translator 432 may otherwise suitably translate voice and other suitable streaming data between the packet and circuit domains without departing from the scope of the present invention.

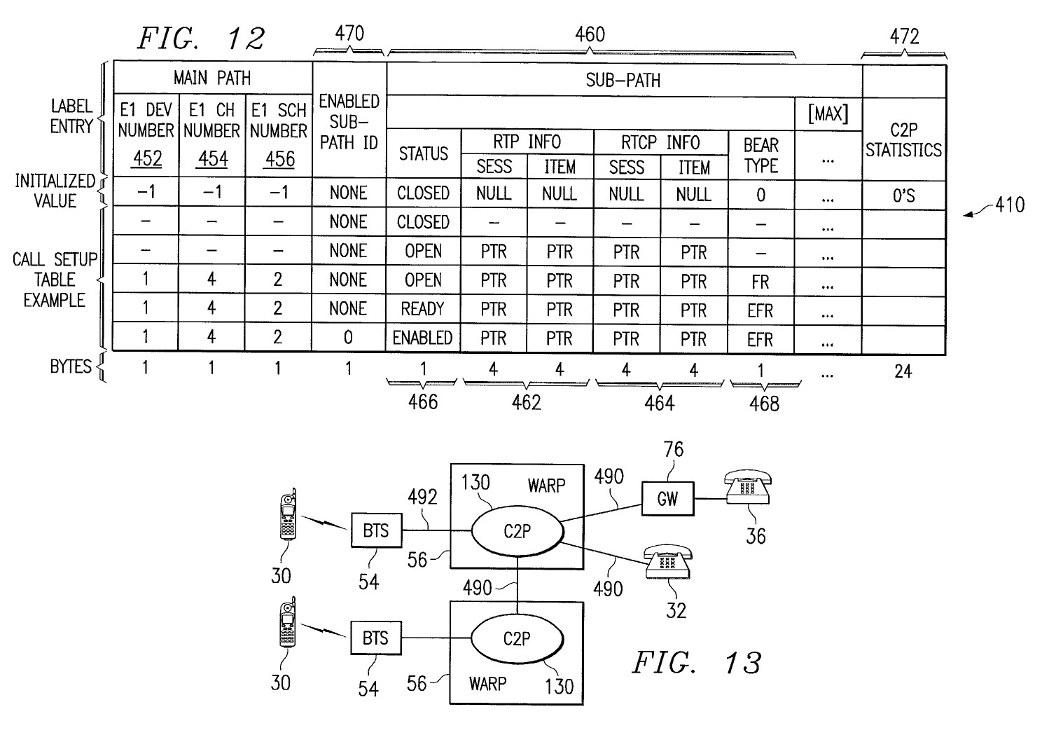

FIG. 12 illustrates details of the bearer path mapping table 410 in accordance with one embodiment of the present invention. In this embodiment, the circuit channels, or main paths 450 comprises a circuit identifier including E1 device, channel and subchannel identifiers 452, 454 and 456, respectively. The bearer path mapping table 410 may be any suitable data storage structure associating corresponding circuit and packet addresses for a connection and operable to be directly indexed with a common key.

The bearer path mapping table 410 maintains one or more packet channels, or subpaths, 460 for each circuit channel 450 up to a maximum (MAX) number. The packet identifier may comprise RTP and RTCP socket identifiers 462 and 464, respectively. For each packet channel 460, a connection status 466 is maintained, as well as a bearer type 468. The connection status moves from closed to open indicating set-up to ready indicating that the remote socket has been received to enabled indicating streaming voice during call set-up and may be selectively disabled and enabled during a call or other streaming connection to provide call waiting, on hold and other enhanced services. Enabled subpath identifier 470 corresponds to the connection status 466 and is also maintained. Circuit-to-packet statistics 472 may also be maintained to provide debugging and trouble-shooting information.

Using the bearer path mapping table 410, the circuit-to-packet unit 130 forwards data from a circuit channel to a packet channel based on a connection status 466 and/or 470 of the packet channels. Thus, data is only forwarded to enabled packet channels. Similarly, only downlinked data from enabled packet channels is translated and forwarded to the circuit channels for delivery to the mobile device 30. In this way, multiple packet channels may be switched onto a single circuit channel and may be efficiently identified in a modular packet interworking unit.

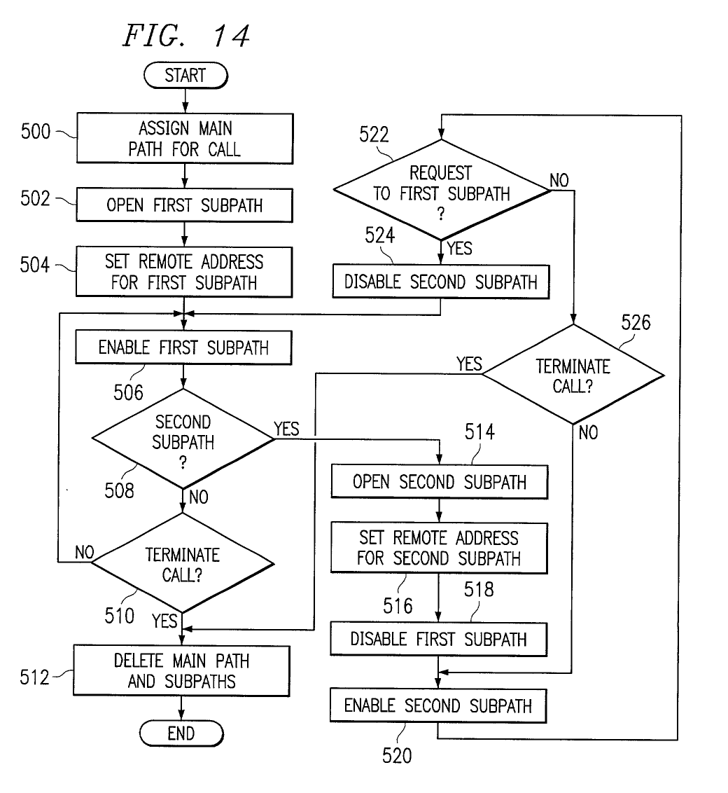

FIG. 13 illustrates multiple packet channels 490 for a single circuit channel 492 in accordance with one embodiment of the present invention. The packet channels may be to a standard telephone 36 over the gateway 76, an IP telephone 32 over the IP network 14 or a second mobile device 30 through a second WARP 56. In each case, the packet channels 490 are maintained by the bearer path mapping table 410 and may be selectively connected to a circuit channel based on user and other suitable input.

FIG. 14 illustrates a method for call setup in the circuit-to-packet unit 130 in accordance with one embodiment of the present invention. In this embodiment, multiple packet channels may be switched on to a single main circuit channel to provide enhanced services to mobile devices 30.

Referring to FIG. 14, the method begins at step 500 in which a main circuit path is assigned for a call. In the GSM embodiment, the main path is assigned with the device, channel and sub-channel identifiers 452, 454 and 456 in the bearer path mapping table 410. At step 502, a first subpath is opened for the main path. In the H.323 embodiment, the first subpath comprises socket identifiers 462 and 464. At step 504, a first remote address is set for the subpath. Next, at step 506, the first subpath is enabled to provide an end-to-end connection across the circuit and packet domains between a circuit endpoint and a first packet endpoint.

Proceeding to decisional step 508, if a second packet subpath is not requested or provided to the user in accordance with subscribed services, the No branch leads to decisional step 510. At decisional step 510, the circuit-to-packet unit 130 determines whether the call has been terminated. If the call has not been terminated, the No branch of decisional step 510 returns to step 506 in which the first subpath remains enabled. If the call is terminated, the Yes branch of decisional step 510 leads to step 512 in which the main path and subpaths are deleted from the bearer path mapping table 410. Step 512 leads to the end of the process.

Returning to decisional step 508, if a second subpath is indicated, the Yes branch leads to step 514 in which a second subpath is opened. At step 516, a remote address is set for the second subpath. At step 518, the first subpath is disabled in the bearer path mapping table 410. The second subpath is enabled in the bearer path mapping table at step 520. Accordingly, a second end-to-end connection across the packet and circuit domain is provided between the circuit endpoint and a second packet endpoint.

Proceeding to decisional step 522, the circuit-to-packet unit 130 determines whether reversion to the first subpath is indicated. If reversion to the first subpath is indicated, the Yes branch of decisional step 522 leads to step 524 in which the second subpath is disabled. Step 524 leads to step 506 in which the first subpath is again enabled to reestablish the first end-to-end connection. If reversion to the first subpath is not indicated, the No branch of decisional step 522 leads to decisional step 526 in which the circuit-to-packet unit 130 determines whether the connection is terminated.

At decisional step 526, if the connection is not terminated, the No branch returns to step 520 in which the second subpath remains enabled. Upon termination, the Yes branch of decisional step 524 leads to step 512 in which the main path and subpaths are deleted from the bearer path mapping table 410. Step 512 leads to the end of the process by which multiple packet channels are enabled and disabled to be selectively switch onto a single circuit channel.

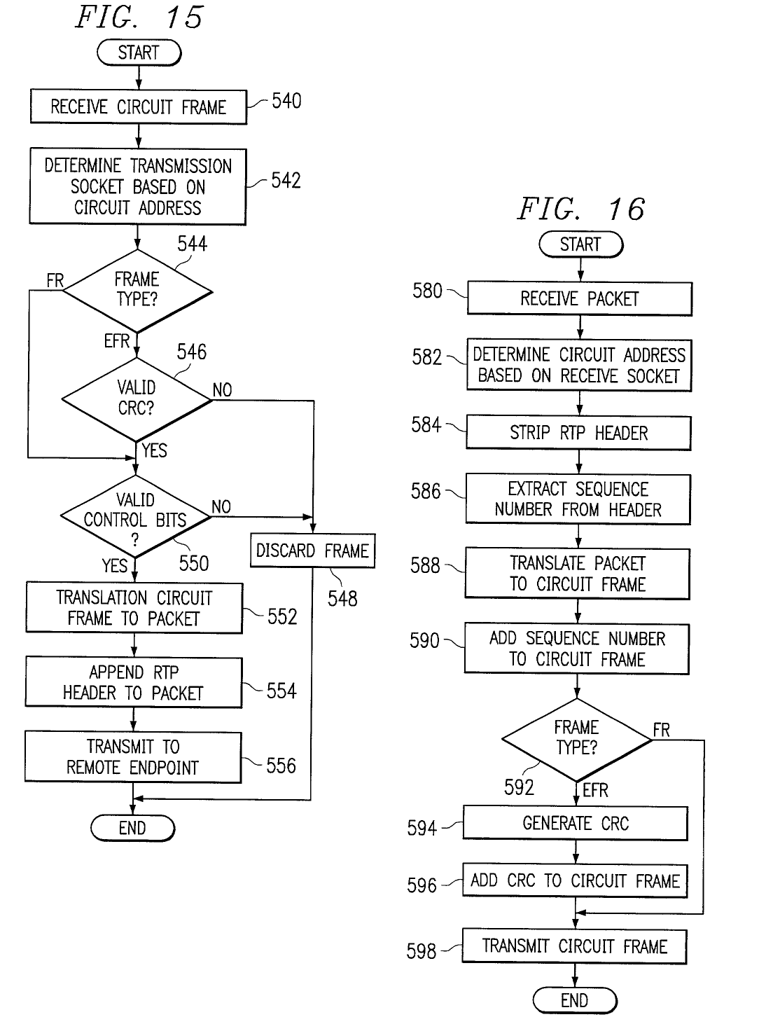

FIG. 15 illustrates a method for processing uplink traffic in the circuit-to-packet unit 130 in accordance with one embodiment of the present invention. In this embodiment, traffic is translated based on a FR or EFR QoS of the connection.

Referring to FIG. 15, the method begins at step 540 in which an uplink circuit frame is received from the TRAAU 108. At step 542, a packet identifier is determined for the connection based on the circuit identifier in the frame. As previously described, the packet identifier may comprise a transmission socket and may be determined by determining the MS key for the connection and then using a common MS key to index into the bearer path mapping table 410. The MS key may be determined by directly indexing into table 410 with the circuit identifier.

Proceeding to decisional step 544, the circuit-to-packet unit 130 determines a frame type by accessing SLR 52. If the frame is for an EFR connection, the EFR branch leads to decisional step 546 in which a cyclic redundancy check (CRC) value is validated for the EFR frame. In this embodiment, the CRC is generated by the TRAAU 108. If the CRC is not valid, the No branch of decisional step 546 leads to step 548 in which the frame is discarded. Step 548 leads to the end of the process and cleaning for the discarded frame is provided at a remote endpoint. If the CRC is valid, the Yes branch of decisional step 546 leads to decisional step 550. In addition, if the uplink circuit frame is for an FR connection, the FR branch of decisional step 544 also leads to decisional step 550.

At decisional step 550, the circuit-to-packet unit 130 determines whether control bits of the uplink circuit frames are valid. If the control bits are not valid, the No branch of decisional step 550 leads to step 548 where the frame is discarded. If the control bits are valid, the Yes branch of decisional step 550 leads to step 552. At step 552, the circuit frame is translated into a packet. In one embodiment, as previously described, disparate translation processes are used for data in FR and EFR frames.

At step 554, a RTP header is appended to the packet. The packet is transmitted to a remote endpoint through the IP network 14 at step 556. In this way, uplink circuit frames are efficiently translated into packets with minimum latency and processing in the circuit-to-packet unit 130.

FIG. 16 illustrates a method for processing downlink traffic in the circuit-to-packet unit 130 in accordance with one embodiment of the present invention. In this embodiment, downlink traffic is processed based on an FR or EFR QoS.

Referring to FIG. 16, the method begins at step 580 in which a downlink packet is received from the IP network 14. At step 582, a circuit identifier is determined based on the packet identifier. As previously described, the circuit identifier may be determined by determining the MS key for the connection based on the received socket and indexing into the bearer path mapping table 410 with the MS key to find the associated circuit identifier. The MS key may be determined by directly indexing into the table 410 with the packet identifier.

Next, at step 84, the RTP header is stripped. At step 586, the sequence number is extracted from the RTP header. At step 588, the packet is translated to a circuit frame. The extracted sequence number is added to the circuit frame at step 590 for sorting of the circuit frames in the jitter buffer 166 of TRAAU 108.

Proceeding to step 592, frame type is determined. If the frame is for an EFR connection, the EFR branch of decisional step 592 leads to step 594 in which a CRC is generated. The CRC is added to the circuit frame at step 596. In this embodiment, the CRC is validated by the TRAAU 108.

At step 598, the circuit frame is transmitted to the TRAAU 108 for processing and delivery to the mobile device 30. Returning to decisional step 592, if the frame is an FR connection, the FR branch leads to step 198 in which the circuit frame is also transmitted to the TRAAU 108 for processing. In this way, downlink packets are efficiently translated to circuit frames to minimize latency in the connection and required processing resources.

Although the present invention has been described with several embodiments, various changes and modifications may be suggested to one skilled in the art. It is intended that the present invention encompass such changes and modification has fall within the scope of the appended claims.

What is claimed is:

1. A method for providing multiple packet channels for a circuit channel across a circuit-to-packet interworking unit, comprising:
establishing a circuit channel;
establishing a plurality of packet channels;
associating each of the packet channels with the circuit channel;
selectively connecting a first one of the packet channels to the circuit channel to provide and end-to-end connection between a circuit endpoint and a first packet endpoint; and
maintaining a second packet channel for selective connection to the circuit channel to provide a second end-to-end connection between the circuit endpoint and a second packet endpoint.

2. The method of claim 1, further comprising selectively connecting the second packet channel to the circuit channel to provide the second end-to-end connection.

3. The method of claim 1, further comprising selectively connecting the first packet channel to the circuit channel in response to user input.

4. The method of claim 2, further comprising selectively connecting the second packet channel to the circuit channel to provide call waiting for the circuit channel.

5. The method of claim 1, further comprising selectively disconnecting the first packet channel from the circuit channel to provide call hold for the circuit channel.

6. The method of claim 1, wherein the circuit channel comprises a wireless circuit channel.

7. The method of claim 1, further comprising selectively connecting the first packet channel to the circuit channel by enabling the first packet channel.

8. The method of claim 2, further comprising selectively disconnecting the first packet channel from the circuit channel prior to connecting the second packet channel to the circuit channel.

9. The method of claim 1, further comprising:
associating the circuit channel with the plurality of packet channels in a bearer path mapping table;
maintaining a connection status for each of the packet channels in the bearer path mapping table; and
providing traffic from the circuit channel to a packet channel having an enabled status in the bearer path mapping table.

10. The method of claim 9, further comprising providing traffic from a packet channel having an enabled status in the bearer path mapping table to the circuit channel.

11. A system for providing multiple packet channels for a circuit channel across the circuit-to-packet interworking unit, comprising:
logic encoded in media; and
the logic operable to establish a circuit channel, establish a plurality of packet channels, associate each of the packet channels with the circuit channel, selectively connect a first one of the packet channels to the circuit channel to provide end-to-end connection between a circuit endpoint and a first packet endpoint and maintain a second packet channel for selective connection to the circuit channel to provide a second end-to-end connection between the circuit endpoint and a second packet endpoint.

12. The system of claim 11, the logic further operable to selectively connect the second packet channel to the circuit channel to provide the second end-to-end connection.

13. The system of claim 1, the logic further operable to selectively connect the first packet channel to the circuit channel in response to user input.

14. The system of claim 12, the logic further operable to selectively connect the second packet channel to the circuit channel to provide call waiting for the circuit channel.

15. The system of claim 11, the logic further operable to selectively disconnect the first packet channel from the circuit channel to provide call hold for the circuit channel.

16. The system of claim 11, wherein the circuit connection comprises a wireless circuit connection.

17. The system of claim 11, the logic further operable to selectively connecting the first packet channel to the circuit channel by enabling the first packet channel.

18. The system of claim 12, the logic further operable to selectively disconnecting the first packet channel from the circuit channel prior to connecting the second packet channel to the circuit channel.

19. The system of claim 11, the logic further operable to associate the circuit channel with the plurality of packet channels in a bearer path mapping table, maintain an enable status for each of the packet connections in the bearer path mapping table and provide traffic from the circuit channel to a packet channel having an enabled connection status in the bearer path mapping table.

20. The system of claim 19, the logic further operable to provide traffic from a packet channel having an enabled connection status in the bearer path mapping table to the circuit channel.

21. A packet interworking function, comprising:
an uplink translator operable to receive a circuit frame including voice data and a circuit identifier for a circuit channel and to generate a packet including the voice data and a packet identifier for an enabled one of a plurality of packet channels associated with the circuit channel; and
a downlink translator operable to receive a packet including voice data and a packet identifier from at least one of the plurality of packet channels and to generate a circuit frame including the circuit identifier and the voice data from the enabled one of the plurality of packet channels associated with the circuit channel.

22. The packet interworking function of claim 21, further comprising a bearer path mapping table operable to associate the circuit channel with the plurality of packet channels and maintain the connection status for each of the packet channels.

23. The method of claim 21, wherein the circuit identifier comprises a device, a channel and a subchannel identifier.

24. The packet interworking function of claim 21, wherein the packet identifier each comprises a socket identifier.
